(19) United States
(12) Patent Application Publication
(10) Pub. No.: US 2021/0349027 A1
(43) Pub. Date: Nov. 11, 2021

(54) LIGHT SHEET FLUORESCENCE MICROSCOPIC IMAGING DEVICE FOR IMAGING TRANSPARENT DROPLET AND TEST METHOD

(71) Applicant: ENUMERIX, INC., Dover, DE (US)

(72) Inventors: Peng FEI, Hubei (CN); Jun MIE, Hubei (CN)

(21) Appl. No.: 17/255,409

(22) PCT Filed: Jun. 27, 2019
(86) PCT No.: PCT/CN2019/093241

§ 371 Date: Jul. 30, 2021

(30) Foreign Application Priority Data
Jun. 27, 2018 (CN) 201810680579.9

(51) Int. Cl. G01N 21/64; C12Q 1/6851

(52) U.S. Cl. CPC G01N 21/6458; G01N 21/6428; G01N 2021/6471; G01N 2021/6478; C12Q 1/6851

(57) ABSTRACT

A light sheet fluorescence microscopic imaging device for imaging transparentized droplets and a detection method are disclosed in the present application. The imaging device comprises a light source shaping module, a light sheet generation module, a sample control module, and an image capturing module. The light source shaping module is used to shape circular light into an elliptical light spot. The light sheet generation module is used to generate a sheet-like light beam according to the elliptical light spot. The sample control module is used to control a sample to move in a direction perpendicular to an optical axis when the sample is illuminated by the sheet-like light beam. The image capturing module is used to capture fluorescent signals excited in different positions when the sample is moving, so as to acquire a three-dimensional image sequence of the sample. The present application can be used to generate elliptical light within a short optical distance, so as to generate a high and thick light sheet, such that the shape of a light beam is more applicable to in-situ closed imaging of deep-layer droplets. At the same time, since no slit is required to block laser light, the energy utilization rate of the laser light is increased by more than four times, thereby improving the clear aperture in a large field of view, reducing the length of a capturing end, and resulting in a reduced volume and higher integration level.

### TECHNICAL FIELD

The present application belongs to the field of biological detection, and more specifically, relates to a light sheet fluorescence microscopic imaging device for imaging transparentized droplets and a detection method.

### RELATED ART

Emulsion droplets are one of powerful tools that are practical and rapidly developing in the field of chemical biology. The emulsion droplets are usually in a size between several micrometers and hundreds of micrometers, especially between 10 micrometers and 300 micrometers, and they exist stably in a water-in-oil emulsion under the action of a specific surfactant. Microemulsion droplets can evenly disperse a sample (mostly an aqueous solution) into multiple units of nearly the same volume, and these units are isolated from each other to form independent reaction spaces, which can greatly increase the flux of the reaction. Since the formed microemulsion droplets are the same or similar in size, they can be used to combined into a large number of small-scale crystalline particles, polymer beads, and the like. Solid particles formed by microemulsion droplets are similar in size, and the synthesis process is easy to regulate.

The independent separation characteristic of the microemulsion droplets can greatly improve the accuracy and resolution of a detection and quantification method based on a limiting dilution strategy, such as a digital chain enzyme reaction.

Light sheet fluorescence microscopy is a method of tomographic illumination using a sheet-like light source. Fluorescence signals of a sample are excited by layer-by-layer scanning to obtain a sequence of fluorescence images, and then three-dimensional reconstruction is performed on multiple frames of images. Compared with ordinary wide-field illumination, the light sheet scanning can effectively avoid out-of-focus excitation by selectively exciting a certain plane, thereby greatly improving the contrast and resolution of imaging, and has the ability of three-dimensional imaging.

For a long time, there has been a demand for a more efficient light sheet fluorescence microscopic imaging device for imaging transparentized droplets and a detection method.

### SUMMARY

A light sheet fluorescence microscopic imaging device for imaging transparentized droplets and a detection method are provided in the present application, thereby solving the problems in the prior art.

A light sheet fluorescence microscopic imaging device for imaging transparentized droplets is provided in the present application, including: a light source shaping module, a light sheet generation module, a sample control module, and an image capturing module. The light source shaping module is used to shape circular light into an elliptical light spot. The light sheet generation module is used to generate a sheet-like light beam according to the elliptical light spot. The sample control module is used to control a sample to move in a direction perpendicular to an optical axis when the sample is illuminated by the sheet-like light beam. The image capturing module is used to capture fluorescent signals excited in different positions when the sample is moving, so as to acquire a three-dimensional image sequence of the sample.

Further, the light source shaping module includes: a laser, an optical fiber collimator, and a beam expanding and shaping module. The optical fiber collimator is used to collimate the circular light emitted by the laser, and the beam expanding and shaping module is used to shape the collimated circular light into the elliptical light spot.

Further, the beam expanding and shaping module includes: a first cylindrical lens, a convex lens, and a second cylindrical lens sequentially arranged on the optical axis, and a focusing direction of the first cylindrical lens and a focusing direction of the second cylindrical lens form an angle of 90°.

Furthermore, long and short axes of the elliptical light spot are f2*d/f1 and f3 *d/f2, respectively; wherein f1, f2, and f3 are respectively the focal lengths of the first cylindrical lens, the convex lens, and the second cylindrical lens, and d is the diameter of an incident light spot.

Furthermore, the focal length f1 of the first cylindrical lens is 10 mm to 20 mm, the focal length f2 of the convex lens is 5 mm to 10 mm, and the focal length f3 of the second cylindrical lens is 15 mm to 30 mm. Preferably, the focal length of the first cylindrical lens is 12.7 mm, the focal length of the second circular lens is 8 mm, and the focal length of the third cylindrical lens is 25 mm.

Furthermore, the convex lens is a circular lens.

Further, the image capturing module includes: an objective lens, a tube lens, a filter, and a camera sequentially arranged on the optical axis, and a fluorescent signal detected by the objective lens is focused on a sensor of the camera through the tube lens to form an image; and the filter is used to transmit a signal of a fluorescent wavelength.

Furthermore, the image capturing module adopts a combination of a medium and high magnification objective lens and a short-focus tube lens to realize the capturing of a high clear aperture under an infinity-corrected large field of view. The magnification of the objective lens is 4× to 20×, and the focal length of the tube lens is 20 mm to 150 mm.

As another embodiment, the image capturing module may also use a short-focus or macro lens, such as Canon EF 50 mm f/1.8, Canon EF 35 mm f/1.4L, Nikon 35 mm f/1.8G ED, and ZEISS Planar T*50 mm f/2 ZM.

In some implementations, multi-channel imaging may be performed by switching a multi-wavelength laser and switching corresponding filters at a capturing end. In addition, for droplets with poor transparency, double-sided light sheet illumination may be used for excitation.

A method for imaging and detecting transparentized droplets based on the above light sheet fluorescence microscopic imaging device is further provided in the present application, which includes the following steps:

(1) preparing transparentized emulsion containing an oil phase and an aqueous phase, wherein the refractive index of the oil phase matches that of the aqueous phase;

(2) performing a dropletization treatment on the transparentized emulsion to obtain transparentized droplets; and

(3) illuminating the transparentized droplets by the sheet-like light beam generated by the light sheet generation module in the light sheet fluorescence microscopic imaging device, and controlling the transparentized droplets to move in a direction perpendicular to the optical axis, thus capturing fluorescent signals excited in different positions when the transparentized droplets are moving, and acquiring a three-dimensional image sequence of the transparentized droplets. Furthermore, in step (1), the refractive index of the oil phase matching that of the aqueous phase specifically refers to that the oil phase and the aqueous phase have the same or similar refractive indexes, wherein the refractive indexes being similar specifically means that a difference between the refractive indexes of the aqueous phase and the oil phase should be within ±0.1. Preferably, the difference between the refractive indexes of the aqueous phase and the oil phase is within ±0.01.

Between step (2) and step (3), there is a step of subjecting the transparentized droplets to a biochemical reaction. The biochemical reaction is preferably a digitalization reaction, and more preferably a digital chain enzyme reaction. When the transparentized droplets are subjected to a biochemical reaction, the aqueous phase in the emulsion is prepared as a reaction solution required for the biochemical reaction, and when the digital chain enzyme reaction is performed, the aqueous phase in the emulsion is prepared as a reaction solution required for the digital chain enzyme reaction.

The structure of two orthogonal cylindrical lenses sandwiching a circular lens is used in the present application to replace the two circular lenses in the prior art and serve as the beam expanding and shaping device, which can generate elliptical light within a short optical distance, so as to generate a high and thick light sheet, such that the shape of a light beam is more applicable to in-situ closed imaging of deep-layer droplets. The device has a shorter overall length and a higher integration level. At the same time, since no slit is required to block laser light, the energy utilization rate of the laser light is increased by more than four times.

The combination of the medium and high magnification objective lens and the short-focus tube lens is used in the present application as the image capturing module, which can increase the clear aperture and reduce the volume of the device. Alternatively, the short-focus or macro lens is used as the image capturing module, which can increase the field of view and reduce the volume of the device.

A scanning imaging and detection method for droplets by using a light sheet is proposed in the present application, which uses sheet-like light source illumination and wide-field acquisition, and compared with the traditional serial detection method, parallel high-flux detection can be performed in the present application.

The volume of the beam expanding and shaping device and the volume of the image capturing module are greatly reduced compared with the prior art; therefore, the device in the present application is small in size, and the size is controlled within 30 cm×30 cm×15 cm. At the same time, the present device can realize the in-situ closed detection of droplets without opening a lid, and the operation is simple and pollution free.

### BRIEF DESCRIPTION OF THE DRAWINGS

FIG. 1 shows that by changing the concentration of a refractive index enhancer, emulsion droplets will exhibit different transparency. In the drawing, the concentration of the refractive index enhancer increases from left to right, the transparency first increases and then decreases, and the transparency is the highest when the concentration is appropriate (third from the right).

FIG. 2 is a schematic diagram of a light sheet fluorescence microscopic imaging device for imaging transparentized droplets according to the present application.

FIG. 3 is a partial enlarged diagram of a sample and a holding part of a light sheet fluorescence microscopic imaging device.

FIG. 4 is a schematic diagram of an existing beam expanding and shaping device and a beam expanding and shaping device described in the present application, the left side is a schematic diagram of the existing beam expanding and shaping device, and the right side is a side view and a top view of the beam expanding and shaping device described in the present application.

FIG. 5 is a schematic diagram of an existing image capturing module (FIG. 5A) and an image capturing module (FIG. 5B) of the device described in the present application.

FIG. 6 shows scanning detection of droplets at different depths by using the device of the present application.

FIG. 7 is a diagram showing a result of single-base mutation detection in a digital chain enzyme reaction of transparentized droplets.

FIG. 8 is a schematic diagram of a fluorescence counting method for transparentized droplets.

In some implementations, the same reference numerals represent the same physical quantities, wherein 11 denotes a laser light source, 12 denotes an optical fiber, 13 denotes a collimator, 14 denotes a beam expanding and shaping device, 15 denotes a reflector; 2 denotes a cylindrical lens; 31 denotes a sample, 32 denotes a sample holder, 33 denotes a displacement console, 34 denotes a displacement console driver; 41 and 541 denote detection objective lenses, 42 and 542 denote tube lenses, 43 denotes a filter, 44 denotes a camera, 311 denotes a centrifuge tube containing a sample, 312 denotes a sample cell, 313 denotes a sample cell base, and 545 denotes an image.

### DETAILED DESCRIPTION

The present invention will be further described in detail below with reference to the accompanying drawings and embodiments. It should be understood that the specific implementations described here are only used to explain the present invention and are not intended to limit the present invention.

Currently common digital quantitative techniques such as digital bacterial counting, digital cell counting, and digital polymerase chain reaction are all based on the uniform separation characteristic of microemulsion droplets. The strategy of these digital quantitative techniques is usually divided into three steps: dropletization and separation of a sample, a reaction for signal amplification, and performing counting processing. There are usually two methods for counting fluorescent droplets: making droplets pass through a microfluidic channel one by one and counting temporally at a fluorescence detection point (a one-by-one counting method); alternatively, spreading droplets on a plane or rotating cylindrical surface, and acquiring information such as positions of fluorescent droplets and the number of the fluorescent droplets through fluorescence imaging (a planar photography method). However, both of the methods have shortcomings. During the one-by-one detection and counting, the droplets are in a flowing state, and the flow rate of an emulsion needs to be stabilized, so additional microfluidic control is required. Especially for an emulsion with high viscosity or dense droplets, it is also necessary to add dilute oil to separate the droplets before the emulsion enters the detection point. In the planar photography method, only three layers of droplets can be photographed. Due to refraction, without special refractive index processing, it is almost impossible to image droplets of deeper layers. In addition, both counting methods require imaging in a specific container, which will inevitably involve the transfer of amplified products, and such an approach is very likely to contaminate subsequent experiments, thus greatly increasing the probability of false positives in subsequent experiments.

In order to avoid contamination caused by the product transfer, a method of in-situ closed reading of a microfluidic plate chip in a centrifuge tube has emerged. However, this method has the following disadvantages: first, the method involves a microfluidic chip processing technology, which is costly, and requires a reaction device that matches the chip (such as a heating device required for a polymerase chain reaction) and a device for reducing evaporation; second, a gas path and a flow path required for the production of microemulsion on the microfluidic chip are complicated, and the quantity of droplets obtained on the microfluidic chip and the speed of generating droplets are far less than those of the method of separating microemulsion droplets, and therefore, the dynamic range and sensitivity of digital detection are limited. To realize in-situ closed reading of optical signals of a large number of microemulsion droplets, the problem of how to image droplets of deeper layers needs to be solved.

A formulation of microemulsion droplets with an aqueous phase and an oil phase having the same or similar refractive indexes is used to transparentize the microemulsion droplets, so that light can pass through shallow-layer transparentized droplets to reach deep-layer droplets, which provides a prerequisite for reading optical signals of the deep-layer droplets. A light sheet fluorescence microscopic imaging device for imaging transparentized droplets is provided in the present invention. By optimizing the design of the optical device, a high and thick light sheet is generated, which can realize in-situ closed imaging of deep-layer droplets, and is advantageous in high flux and pollution free. At the same time, the present device is small in size, simple in operation, and low in cost.

At present, the light sheet fluorescence microscopic technology usually uses a beam expanding lens and an adjustable slit diaphragm to generate a high and thin or short and thick light sheet. The high and thin light sheet has a high resolution but a narrow focus range (which can be understood as an available range), the short and thick light sheet has a large available range, but the light sheet is very short. Therefore, this type of light sheets is suitable for imaging small organisms or tissues, such as zebrafish embryos, fruit flies, and mouse brains, but not suitable for deep in-situ closed imaging of a large sample such as a large number of droplets. In addition, the existing light sheet microscope system has a relatively large volume, a high cost, and a cumbersome operation, and part of the laser light is blocked by a slit diaphragm, which reduces the energy utilization rate.

According to one aspect of the present invention, a light sheet fluorescence microscopic imaging device for imaging transparentized droplets is provided, including: a light source shaping module, a light sheet generation module, a sample control module, and an image capturing module. The light source shaping module is used to shape circular light into an elliptical light spot. The light sheet generation module is used to generate a sheet-like light beam according to the elliptical light spot. The sample control module is used to control the sample to move in a direction perpendicular to an optical axis when the sample is illuminated by the sheet-like light beam. The image capturing module is used to capture fluorescent signals excited in different positions when the sample is moving, so as to acquire a three-dimensional image sequence of the sample.

In some implementations, the light source shaping module includes: a laser, an optical fiber collimator, and a beam expanding and shaping module. In some implementations, the optical fiber collimator is used to collimate the circular light emitted by the laser. In some implementations, the beam expanding and shaping module is used to shape the collimated circular light into the elliptical light spot. This elliptical light can generate a thick and tall light sheet without blocking by using a slit, which greatly improves the utilization rate of laser energy, and is suitable for a large sample such as microemulsion droplets.

In some implementations, the beam expanding and shaping module includes: a first cylindrical lens, a convex lens, and a second cylindrical lens sequentially arranged on the optical axis. In some implementations, a focusing direction of the first cylindrical lens and a focusing direction of the second cylindrical lens form an angle of 90°. This placement mode can adjust long and short axes of the elliptical light spot respectively by changing the focal lengths of the cylindrical lenses.

In some implementations, the focal lengths of the first cylindrical lens, the convex lens, and the second cylindrical lens are f1, f2, and f3, respectively, the diameter of an incident light spot is d, and an elliptical light spot with short and long axes being respectively f2*d/f1 and f3*d/f2 is generated. In some implementations, in order to reduce the size of the device as much as possible without affecting the performance of the device, f1 is 10 mm to 20 mm, f2 is 5 mm to 10 mm, and f3 is 15 mm to 30 mm. In some implementations, the focal length of the first cylindrical lens may be 12.7 mm. In some implementations, the focal length of the convex lens may be 8 mm. In some implementations, the focal length of the second cylindrical lens may be 25 mm.

In some implementations, the convex lens may be a circular lens.

In the beam expanding and shaping device, two cylindrical lenses are placed such that focusing directions thereof form an angle of 90 degrees, thus generating an elliptical light spot. The focal lengths of the first lens and the third lens may be adjusted according to actual needs. For example, increasing the focal length of the first lens can reduce the short axis, and increasing the third lens can increase the long axis. Assuming that the focal lengths of the three lenses are f1, f2, and f3, respectively, the diameter of the incident light spot is d, and a light spot with the short and long axes being f2*d/f1 and f3 *d/f2 respectively may be generated, thus forming elliptical light with an axial ratio of f1 *f3/f2². For example, for the droplet detection without opening a lid, it is probably necessary to generate a light sheet with a thickness of about 20 μm and a height of about 10 mm. It may choose to use the first cylindrical lens with a focal length of 12.7 mm, the second circular lens with a focal length of 8 mm, and the third cylindrical lens with a focal length of 25 mm. A beam expanding and shaping device of the existing light sheet microscope often uses two beam expanding methods. One method is expanding the beam by using two circular lenses and blocking the beam by using a slit to adjust the thickness of the light sheet and field of view. The other method is a beam expanding and shaping device proposed by Dodt et al. (“Image enhancement in ultramicroscopy by improved laser light sheets”, Saiedeh et al; J Biophotonics Vol. 3, No. 10-11, pages 686-695) that uses a concave lens followed by two orthogonally placed cylindrical lenses. When a light sheet of the same thickness is generated, such as a light sheet with a thickness of 20 μm and a height of 10 mm, the size of the incident light in the focusing direction is about 2 mm. For the first beam expanding and shaping device mentioned above, the height of the light sheet is not enough if a 2 mm light spot is used. If a large light spot is used, a large amount of laser light needs to be blocked. The device in the present application can generate a suitable light sheet without blocking the laser light, and the energy utilization rate can be increased by more than four times. Compared with the above second beam expanding and shaping method, the device in the present application has the following advantages: first, the device in the present application is more flexible, and elliptical light beams in different shapes can be obtained by replacing the first lens (cylindrical lens) or the third lens (cylindrical lens) with a suitable focal length to meet different requirements. For example, when the first cylindrical lens with f1=15 mm, the circular lens with f2=10 mm, and the second cylindrical lens with f3=30 mm are used, an elliptical light beam of 2.2 mm*10 mm (the incident light diameter being 3.3 mm) may be formed. The beam expanding and shaping device has a length of 65 mm, and a light sheet with a thickness of 20 μm and a height of 10 mm can be finally formed, which is suitable for in-situ imaging of droplets. Second, the beam expanding device is small in size, and if the Dodt method is used, when an elliptical light beam in a similar size is generated, a circular lens with f=20 mm and cylindrical lenses with f=15 mm and f=60 mm are required to form an elliptical light spot of 2.5 mm*10 mm. However, the overall length of the beam expanding and shaping device is 80 mm, and it can be seen that the device of the present application has reduced the volume of the beam expanding and shaping device.

In some implementations, the light sheet generation module includes: a reflector and a third cylindrical lens sequentially arranged on the optical axis. The reflector reflects the elliptical light onto the third cylindrical lens and forms a sheet-like light beam at a focal point of the third cylindrical lens.

In some implementations, the sample control module includes: a three-dimensional translation stage and a controller thereof, a sample holder, and a sample cell. A sample is placed in the holder of the above device, and a lower end of the sample is immersed in the sample cell filled with a refractive index matching liquid. Positions of the droplets are adjusted so that the droplets are illuminated by the light sheet, the translation stage drives the droplets for scanning, and a camera continuously records images in different positions to obtain a series of images. Three-dimensional reconstruction may be performed on the droplets through an algorithm or software to realize counting and positioning.

In some implementations, the sample is fixed on a displacement console by the holder. The holder may be directly compatible with a container containing transparent droplets, such as a centrifuge tube. The part containing transparent droplets of a lower end of the container containing the transparent droplets is immersed in a container containing a refractive index matching liquid to achieve detection without opening a lid. The part of the lower end of the container containing the transparent droplets is immersed in the sample cell containing the refractive index matching liquid (such as water and glycerin). For digital PCR counting, it is necessary to maintain a certain temperature, and a heating or cooling method such as an electric heater and a semiconductor refrigeration sheet can be used, or a method such as circulated cooling or circulated heating can be used to make the sample reach and/or maintain a certain temperature. The holder is fixed on the three-dimensional translation stage, and the sample is driven to be scanned by controlling the translation stage.

In some implementations, the image capturing module includes: an objective lens, a tube lens, a filter, and a camera sequentially arranged on the optical axis, the magnification of the objective lens may be 4× to 20×, and the focal length of the tube lens may be 20 mm to 150 mm. The fluorescent signal detected by the objective lens is focused on a sensor of the camera through the tube lens and is recorded to form an image. The filter can transmit a signal near a fluorescent wavelength and block a signal of a non-fluorescent band.

In some implementations, a tube lens with a focal length of 100 mm may be used, a distance between the objective lens and the tube lens is 0 mm to 100 mm, and a distance between the tube lens and the camera is 60 mm.

In some implementations, the image capturing module adopts a combination of a medium and high magnification objective lens and a short-focus tube lens to realize image acquisition under infinity-corrected large field of view and high clear aperture. The focal length of the short-focus tube lens may be 20 mm to 150 mm, and the magnification of the medium and high magnification objective lens may be higher than 2×, 3×, or 4×, or lower than 20×, for example, 4× to 20×. In particular, the magnification of the medium and high magnification objective lens is, for example, 4×, 5×, 6×, 7×, 8×, 9×, 10×, 11×, 12×, 13×, 14×, 15×, 16×, 17×, 18×, 19×, or 20×. In some implementations, the magnification of the medium and high magnification objective lens is 4×. The actual magnification is determined by a ratio of the focal length of the tube lens to the focal length of the objective lens. For example, the focal length of the 4× lens is 50 mm, the magnification of a matching 200 mm standard tube lens is four times, and the magnification of a matching 100 mm short-focus tube lens is equivalent to twice. When samples of the same size are observed, the existing image capturing module usually uses a combination of an objective lens with a magnification of 2× and a tube lens with a focal length of 200 mm to achieve infinity-corrected imaging. For example, when a 4×/0.13 objective lens and a tube lens with f=100 mm are used, the actual magnification is 2. Compared with the standard 2×/0.06 objective lens and a tube lens with f=200 mm, the device in the present application can increase the light input by five times. It is conducive to capturing weak signals under a large field of view, and at the same time, the length of the entire detection device can be reduced by 16 cm or more. Here, under the same magnification, the clear aperture of the objective lens can be increased, the field of view can be enlarged, and the volume of the device can be reduced in the present application. Optionally, an objective lens with a higher magnification and a tube lens with a shorter focal length can be used to achieve a larger clear aperture and further reduced size. In the case of using a combination of an ultra-high magnification objective lens and a special short-focus tube lens, a working distance of the ultra-high magnification objective lens is short, and the lower edge of the large field of view may have obvious distortion.

In some implementations, the image capturing module may also use a short-focus or macro lens (such as Canon EF 50 mm f/1.8, Canon EF 35 mm f/1.4L, Nikon 35 mm f/1.8G ED, and ZEISS Planar T*50 mm f/2 ZM) instead of objective lens-lens to form a finite-distance correction system. This system can increase the field of view, and reduce the size of the device and the complexity of the system. The comparison of data such as the field of view size of the light sheet fluorescence microscopic imaging device using the macro lens and the commercially available light sheet fluorescence microscopic imaging device is shown in Table 1:

TABLE 1

| | | | Field of | | |
|---|---|---|---|---|---|
| | | | View | System | Representative |
| | Flux | Resolution | Size | Complexity | Product |
| SPIM (2X | On the | Horizontal | 6.6 mm × | [symbol] [symbol] | Lavision |
| objective | order of | direction~8 μm | 6.6 mm | | Ultramicroscopy |
| lens) | 2*10¹⁰ | Axial direction | | | (2 million to 3 |
| | μm³/s at | 15 μm to 25 | | | million) |
| | most | μm | | | |
| DSLM (2X | On the | Horizontal | 6.6 mm × | [symbol] [symbol] [symbol] [symbol] | Zeiss Lightsheet |
| objective | order of | direction~8 μm | 6.6 mm | | Z.1 (3 million to |
| lens) | 10¹⁰ | Axial direction | | | 5 million) |
| | μm³/s at | 15 μm to 25 | | | |
| | most | μm | | | |
| Bessel (2X | On the | Horizontal | 6.6 mm × | [symbol] [symbol] [symbol] [symbol] [symbol] | 3i-Lattice |
| objective | order of | direction~8 μm | 6.6 mm | | LightSheet (Have |
| lens) | 2*10¹⁰ | Axial | | | not entered the |
| | μm³/s at | direction~4 μm | | | Chinese market) |
| | most | | | | |
| Confocal | On the | Horizontal | 5 mm × | [symbol] [symbol] [symbol] [symbol] [symbol] | Nikon, Olympus, |
| (4X | order of | direction~3 μm | 5 mm | | Zeiss (1 million |
| objective | about | Axial | | | to 3 million) |
| lens) | 10⁷ | direction~15 | | | |
| | μm³/s | μm | | | |
| The | On the | Horizontal | 9 mm × | [symbol] | — |
| present | order of | direction~10 | 9 mm | | |
| device | 4*10¹⁰ | μm | | | |
| (macro | μm³/s at | Axial | | | |
| lens) | most | direction~20 | | | |
| | | μm | | | |

In some implementations, the light sheet fluorescence microscopic imaging device includes a plurality of imaging channels. In some implementations, the light sheet fluorescence microscopic imaging device includes a multi-wavelength laser and a corresponding filter at an image capturing end.

In some implementations, for droplets with poor transparency, double-sided light sheet illumination may be used for excitation on the light sheet fluorescence microscopic imaging device, so that the effective penetration in the horizontal direction can be doubled, and the penetration depth in the axial direction can also be increased obviously. In some implementations, two cylindrical lenses are used for face-to-face illumination, and the two light sheets are precisely aligned.

A method for imaging and detecting transparentized droplets is further provided in the present application, which includes the following steps: (1) preparing transparentized emulsion containing an oil phase and an aqueous phase, wherein the refractive index of the oil phase matches that of the aqueous phase; (2) performing a dropletization treatment on the transparentized emulsion to obtain transparentized droplets; and (3) detecting the transparentized droplets. In some implementations, the transparentized droplets are illuminated by a sheet-like light beam, and the transparentized droplets are controlled to move in a direction perpendicular to the optical axis, such that fluorescent signals excited in different positions when the transparent droplets are moving are captured, and a three-dimensional image sequence of the transparentized droplets is obtained. In some implementations, a method for imaging and detecting transparentized droplets using a light sheet fluorescence microscopic imaging device is further provided, which includes the following steps: (1) preparing transparentized emulsion containing an oil phase and an aqueous phase, wherein the refractive index of the oil phase matches that of the aqueous phase; (2) performing a dropletization treatment on the transparentized emulsion to obtain transparentized droplets; and (3) detecting the transparentized droplets by using the light sheet fluorescence microscopic imaging device. In some implementations, the light sheet fluorescence microscopic imaging device is the light sheet fluorescence microscopic imaging device described in the present application. In some implementations, the transparentized microemulsion droplets are obtained by matching the refractive indexes of the oil phase and the aqueous phase, so as to realize the imaging and detection of deep-layer droplets. In some implementations, a centrifuge tube containing the microemulsion droplets is placed in the holder of the light sheet fluorescence microscopic imaging device described in the present application, and the positions of the droplets are adjusted so that the droplets are illuminated by the light sheet, and the translation stage is made to drive the droplets for scanning, and at the same time the camera is caused to continuously record images in different positions to obtain a series of images. Three-dimensional reconstruction may be performed on the droplets by using an algorithm or software, and counting and positioning are realized.

In order to achieve in-situ closed imaging and counting of microemulsion droplets, it is necessary to be able to acquire image signals of deep-layer droplets. The microemulsion droplets are transparentized so that light rays can pass through the shallow-layer transparent droplets to reach the deep-layer droplets, which provides a prerequisite for reading optical signals of the deep-layer droplets. Transparentized emulsion contains an aqueous phase and an oil phase, the aqueous phase accounts for about 5% to 90% of the emulsion volume, such as about 5%, about 10%, about 15%, about 20%, about 25%, about 30%, about 35%, about 40%, about 45%, about 50%, about 55%, about 60%, about 65%, about 70%, about 75%, about 80%, about 85%, and about 90%. In some implementations, the aqueous phase in the transparentized emulsion accounts for about 10% to 30% of the emulsion mentioned. In some implementations, a refractive index enhancer is added to the aqueous phase. In some implementations, the refractive index of the refractive index enhancer is higher than about 1.330. In some implementations, the refractive index of the refractive index enhancer is higher than about 1.350, about 1.360, about 1.370, about 1.380, about 1.390, about 1.400, about 1.410, or about 1.420. In some implementations, the refractive index of the refractive index enhancer is about 1.420. In some implementations, a surfactant is added to the oil phase. In some implementations, the refractive indexes of the aqueous phase and the oil phase are the same or similar to ensure that the generated microemulsion droplets are transparent. In some implementations, the refractive indexes being similar specifically means that a difference between the refractive indexes of the aqueous phase and the oil phase should be within about ±0.3, about ±0.25, about ±0.2, about ±0.15, or about ±0.1. In some implementations, the difference between the refractive indexes of the aqueous phase and the oil phase is within about ±0.09, about ±0.08, about ±0.07, about ±0.06, about ±0.05, about ±0.04, about ±0.03, about ±0.02, or about ±0.01.

In some implementations, the dropletization method of the transparentized emulsion may be a method such as oscillating emulsification, microfluidic T-channel dropletization, or centrifugal droplet emulsification as described in Chinese patent application (application No. CN201610409019.0, publication No. CN106076443A). With these methods, droplets with adjustable diameter and good uniformity can be obtained.

In some implementations, the performing imaging and detection on transparentized droplets by using the light sheet fluorescence microscopic imaging device described in the present application includes: performing three-dimensional scanning on the emulsion to obtain three-dimensional information of a space where the emulsion is located, and finally reconstructing these images and calculating the number of fluorescent droplets therein. The device and method described in the present application can realize high-speed scanning of droplets, achieve the purpose of high-flux detection, and can be used for digital chain enzyme reaction detection, cell detection, and the like. After a fluorescence image signal of each plane in the emulsion is obtained by using the light sheet fluorescence microscopic imaging device, the picture signal needs to be processed. The signal obtained may be a single read signal at an end point, or multiple signals in a time series. For digital quantitative detection and other end-point signal reading situations, the objective is to obtain the number of fluorescent droplets from the signal. For long-term observations, such as monitoring of movement of cells and bacteria in the emulsion droplets, or monitoring of the number of proliferation, signals in the time series must be obtained.

In some implementations, the image signal processing process is mainly divided into two steps: denoising and counting. For example, Matlab is used to write a program, the number of fluorescent droplets in the transparent emulsion is obtained after steps such as light field correction, three-dimensional droplet reconstruction, Gaussian filtering and smoothing, corrosion and signal enhancement, and local extreme point calculation. In some implementations, the denoising method may be neighborhood averaging, median filtering, Gaussian filtering, Fourier filtering, optimal threshold segmentation, or the like, or a combination thereof. In some implementations, the principles such as local extreme and connected domains may be used to perform positioning and counting on the fluorescent droplets.

In some implementations, between step (2) and step (3), there is a step of subjecting the transparentized droplets to a biochemical reaction. In some implementations, the biochemical reaction is a digitalization reaction. In some implementations, the biochemical reaction is a digital chain enzyme reaction.

In some implementations, when the transparentized droplets are subjected to a biochemical reaction, the aqueous phase in the emulsion is prepared as a reaction liquid required for the biochemical reaction. In some implementations, when the digital chain enzyme reaction is performed, the aqueous phase in the emulsion is prepared as a reaction solution required for the digital chain enzyme reaction.

In some implementations, the expanding and shaping module in the light sheet fluorescence microscopic imaging device described in the present application includes a first cylindrical lens, a convex lens, and a second cylindrical lens sequentially arranged on the optical axis, wherein the focusing direction of the cylindrical lens and the focusing direction of the second cylindrical lens form an angle of 90°. In some implementations, a structure of two orthogonal cylindrical lenses sandwiching a circular lens is used instead of the two circular lenses in prior art to serve as a beam expanding and shaping device, which can generate an elliptical light spot within a short optical distance, thereby generating a tall and thick light sheet, so that the shape of the light beam is more applicable to in-situ closed imaging of deep-layer droplets. As a result, the light sheet fluorescence microscopic imaging device described in the present application has a shorter overall length and a higher integration level. At the same time, since there is no need to use a slit to block the laser, the laser energy utilization rate of the light sheet fluorescence microscopic imaging device described in the present application is increased by more than four times.

A combination of a medium and high magnification objective lens and a short-focus tube lens is used in the present application as the image capturing module, which can increase the clear aperture and reduce the volume of the device. Alternatively, a short focus or macro lens is used as the image capturing module, which can increase the field of view and reduce the volume of the device.

Since the volume of the beam expanding and shaping device and the volume of the image capturing module are greatly reduced compared with the prior art, the light sheet fluorescence microscopic imaging device described in the present application is small in size, and the size is controlled within 30 cm×30 cm×15 cm. At the same time, the present device can realize the in-situ closed detection of droplets without opening a lid, and the operation is simple and pollution free.

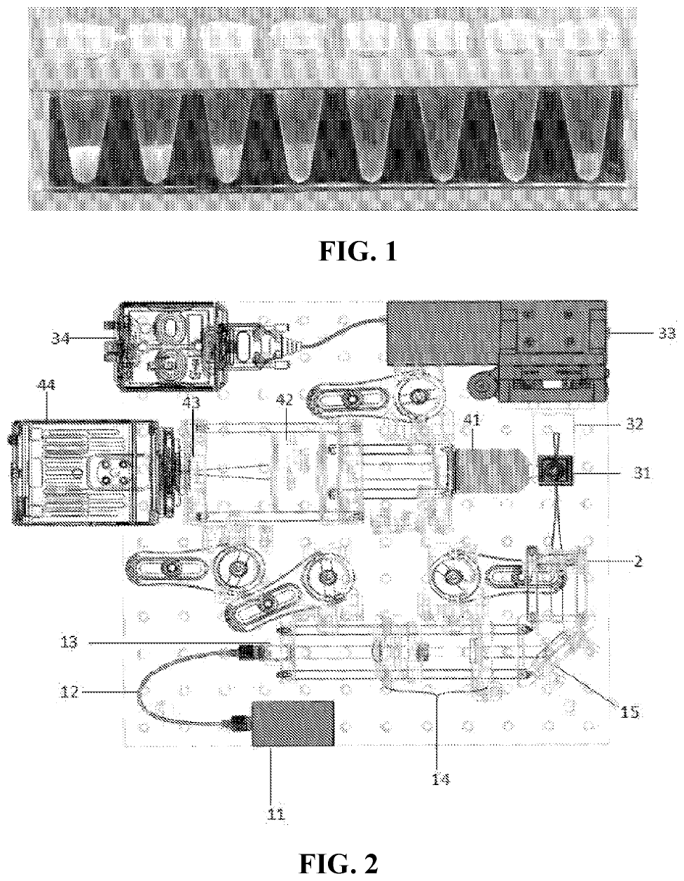

In some implementations, for the preparation of transparentized droplets, in order to select a suitable concentration of the refractive index enhancer, Gelest DMS-T01.5 silicone oil and surfactant Dow Corning ES5612 are prepared at a mass ratio of 19:1, and the evenly mixed mixture is centrifugated in a condition of 20,000 rcf for 10 minutes, the supernatant is obtained for emulsified oil in the next step. Betaine in the aqueous phase is the refractive index enhancer. The volume of the aqueous phase for each sample is 20 μL, and 240 μL of the above-prepared oil is added to the system. FIG. 1 shows the addition of the refractive index enhancer of 0.5, 1.0, 1.5, 2.0, 2.5, 3.0, 3.5, and 4.0 moles per liter respectively from left to right. As can be seen from FIG. 1, as the concentration of the refractive index enhancer increases, the transparency first increases and then decreases, and the transparency is the highest when the concentration of the refractive index enhancer is 3.0 moles per liter (third from the right).

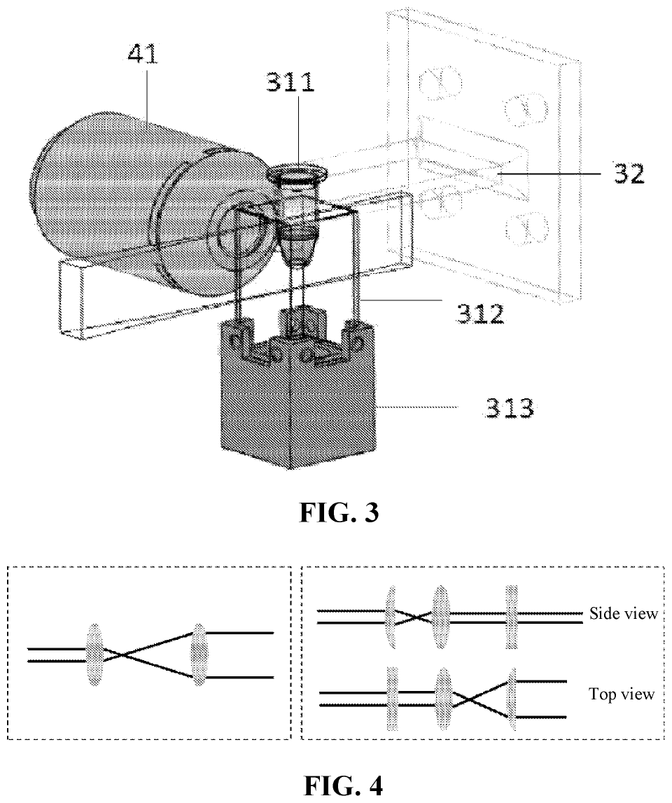

FIG. 2 shows an example overall structure of a light sheet fluorescence microscopic imaging device described in the present application, and FIG. 3 shows a partial enlarged diagram of a sample and a holding part of the light sheet fluorescence microscopic imaging device. As shown in FIG. 2, in an example light sheet fluorescence microscopic imaging device, laser light generated by laser light source 11 is transmitted to collimator 13 via optical fiber 12, and then the light beam is expanded and shaped by beam expanding and shaping device 14 to form elliptical light. The elliptical light is reflected on cylindrical lens 2 by reflector 15 to form a light sheet at the focal point of cylindrical lens 2. Sample 31 is illuminated by the light sheet, the sample is fixed on displacement console 33 by sample holder 32, and displacement console driver 34 controls the translation stage to perform scanning. The excited signal is detected by objective lens 41 and is focused by tube lens 42 onto camera 44, and filter 43 is placed in front of the camera to filter out stray light. As shown in FIG. 3, sample cell 312 is placed on sample cell base 313, and the excited signal passes through objective lens 41 to detect the sample contained in centrifuge tube 311 of sample cell 312.

FIG. 4 shows structures of the existing beam expanding and shaping device (picture on the left) and the beam expanding and shaping device described in the present application (picture on the right). The picture on the left picture shows the existing beam expanding and shaping device, which uses two circular lenses. The picture on the right shows the beam expanding and shaping device in the present application, including the first cylindrical lens, the circular lens, and the second cylindrical lens sequentially from left to right. As shown in FIG. 4, the focal lengths of the cylindrical lens-circular lens-cylindrical lens of the beam expanding and shaping device may be, for example, 12.7 mm, 8 mm, and 25 mm, respectively. The light emitted by the laser light source is transmitted through the optical fiber and passes through the collimator to form a light spot of 3.3 mm. After the light spot is expanded and shaped by the light source and its adjusting device, an elliptical light spot of 2 mm*10 mm may be formed.

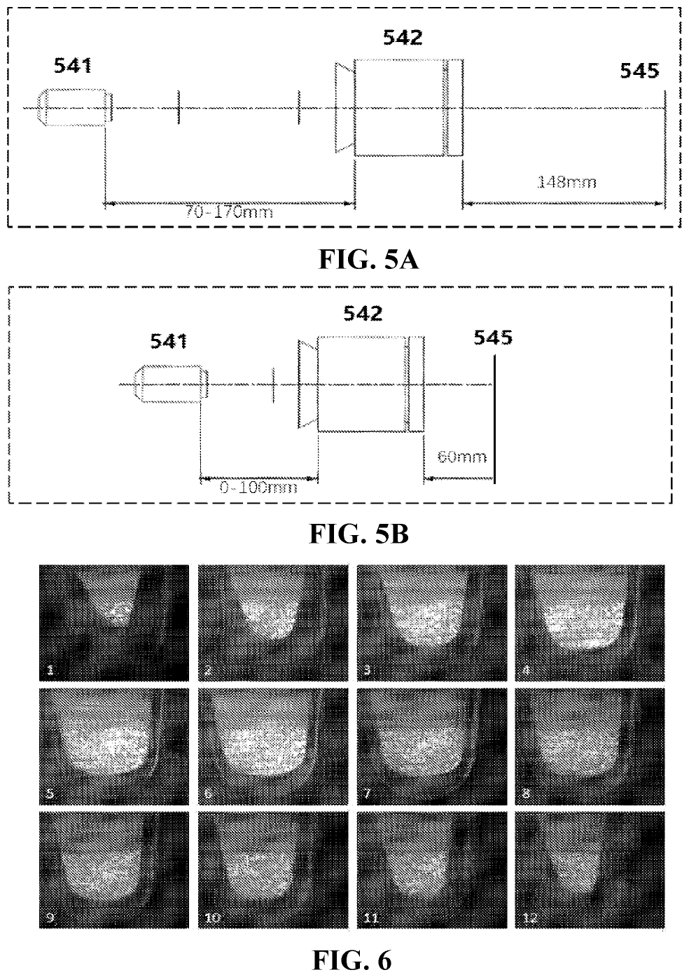

FIG. 5 shows the existing image capturing module (FIG. 5A) and the image capturing module described in the present application (FIG. 5B). As shown in FIG. 5A, a distance between objective lens 541 and tube lens 542 of the existing image capturing module is about 70 mm to 170 mm, and a distance between tube lens 542 and image 545 is about 148 mm. As shown in FIG. 5B, in the image capturing module described in the present application, the distance between objective lens 541 and tube lens 542 can be greatly reduced, for example, it may be 0 mm to 100 mm, and the distance between tube lens 542 and image 545 may be 60 mm. For example, the image capturing module may use an objective lens of 4×/0.13 and a tube lens with f=100 mm, which can achieve a large field of view of 2×. Compared with the standard 2× objective lens and the tube lens with f=200, the effective light input is increased by more than five times, and the size is reduced by 16 cm and more. The three-dimensional size of the entire device is controlled at 30 cm×30 cm×15 cm, and the weight is less than 5 kg, which is small and light.

Another implementation of the image capturing module in the present application may use a short-focus or macro lens (such as Canon EF 50 mm f/1.8) to form a finite-distance correction system.

In some implementations, a beam expanding device consisting of two orthogonal cylindrical lenses and an aspheric lens may be used. The focal lengths of the cylindrical lens-circular lens-cylindrical lens are respectively 12.7 mm, 8 mm, and 25 mm, thereby generating a light sheet with a thickness of 20 μm and a height of 10 mm. A combination of an objective lens of 4×/0.13 and a tube lens with f=100 mm is used as the image capturing module. The Gelest DMS-T01.5 silicone oil and the surfactant Dow Corning ES5612 are prepared at a mass ratio of 19:1, the evenly mixed mixture is centrifugated in a condition of 20,000 rcf for 10 minutes, and the supernatant is obtained for emulsified oil in the next step. Betaine in the aqueous phase is the refractive index enhancer. The volume of the aqueous phase is 20 μL, 240 μL of the above-prepared oil is added to the system, the liter refractive index enhancer of 3.15 moles per liter is added, and a green fluorescent dye is added to manufacture transparentized emulsion. The method in CN106076443A is used to perform centrifugal droplet emulsification on the transparentized emulsion. The number of holes in a used orifice plate is 37, the rotation speed is 15,000 rcf, and the time is 4 minutes, so as to generate a large number of microemulsion droplets with a diameter of about 41 μm. The present device is used for scanning imaging, the laser excitation wavelength is 488 nm, the scanning step length is 5 μm, and the frame rate is 100 FPS. FIG. 6 is an image effect diagram of selecting droplets at different depths, wherein 1 to 12 represent fluorescence images of excitation planes at different depths at an interval of 200 μm. As can be seen, the present device can also image deep-layer droplets clearly.

In some implementations, the device and methods described in the present application may be used for imaging and detection of a digital chain enzyme reaction mixture containing transparentized microemulsion droplets. In some implementations, the microemulsion droplets in the reaction mixture are subjected to light sheet scanning imaging detection after the reaction is completed.

### Embodiments

The following embodiments are illustrations of the implementations described in the present application, and should not be construed as limiting the scope of the implementations.

Embodiment 1 Imaging and detection of a reaction mixture by using the device described in the present application

A TaqMan® MGB (Applied Biosystem™) probe is used to detect single-base mutations in the genome. There is only one base difference in a single base mutation, which is the most demanding in nucleic acid detection. There is a mutation on No. 8 chromosome in the genome of a tested volunteer, an SNP number thereof is rs10092491, and a mutation sequence is ATTCCAGATAGAGCTAAAACTGAAG[C/T]TTTCCTTATAGAGATTTATCCTAGT.

1. Primers and probes for detection:

| | | In a 20X |
|---|---|---|
| | Sequence | mixture |
| Forward | 5′-TCTGTGATAGAGTGGCATTAGAAATTC-3′ | 18 μM |
| primer | | |
| Reversed | 5′-CCCCGCAAACTAACTAGGATAAATC-3′ | 18 μM |
| primer | | |
| FAM-probe | (FAM)-5′-CTAAAACTGAAGCTTTC-3′- | 5 μM |
| | (MGBNFQ) | |
| HEX-probe | (HEX)-5′-AACTGAAGTTTTCCTTATAG-3′- | 5 μM |
| | (MGBNFQ) | |

The above oligonucleic acid is prepared into a 20× mixture according to the concentration in the third column of the above table.

2. Preparation of a chain enzyme reaction solution:

| | Concentration | Concentration | Added |
|---|---|---|---|
| Component | before dilution | after dilution | volume |
| 10× buffer-Mg* | 10× | 1× | 10 μL |
| MgCl₂* | 50 mM | 4 mM | 8 μL |
| Betaine solution | 5M | 3.15M | 63 μL |
| dNTP | 10 mM, each | 400 nM, each | 4 μL |
| PlatinumTaq ® | — | — | 1.5 μL |
| 20× mixture | 20× | 1× | 5 μL |
| DNA sample | — | — | 5 μL |
| under test | | | |
| Water | — | — | 3.5 μL |

*All are included in the PlatinumTaq ® product.

3. Preparation of emulsified oil:

The Gelest DMS-T01.5 silicone oil and the surfactant Dow Corning 5612 are prepared according to a mass ratio of 19:1, the evenly mixed mixture is centrifugated in a condition of 20,000 rcf for 10 minutes, and the supernatant is obtained for emulsified oil in the next step.

4. Generation of centrifugal droplets:

The method described in the Chinese patent application (application No. CN201610409019.0) is used to generate droplets. A microchannel array orifice plate with 37 orifices and 6 μm is adapted, 15 μl the prepared chain enzyme reaction solution of is added to a complex of the microchannel array plate and a capturing device. The capturing device is a 200 μL PCR tube, and the PCR tube contains 240 μL the above emulsified oil, centrifugation is performed at a speed of 15,000 rcf and a time of 4 minutes, thus generating 600,000 transparentized droplets with an average diameter of about 41 micrometers.

5. Thermal cycle:

The above droplets are placed in a thermal cycler and heated up according to the process in the table below.

| Heated | | Heated lid | |
|---|---|---|---|
| lid | 105° C. | before cycle | Open |
| Step 1 | Let stand | 25° C. | 120 s |
| Step 2 | Thermal | 95° C. | 120 s |
| | activation | | |
| | of enzyme | | |
| Step 3 | Thermal cycle | 40 rounds | — |
| Step 3.1 | Denaturation | 92° C. | 15 s |
| Step 3.2 | Annealing | 58° C. | 30 s |
| Step 4 | Cryopreservation | 4° C. | Continuously |

After calculation, the quantity of DNAs in the sample under test in the chain enzyme reaction solution meets the expectation. The average size of the droplets is about 41 μm, and the total number is 6.0*10\hat{ }5. The number of input DNA molecules is about 1.26×10\hat{ }4 after being quantified by a commercial digital PCR. About 1.23\hat{ }4 fluorescent droplets are obtained in the detection method in the present application, which complies with the expectation of the Poisson distribution.

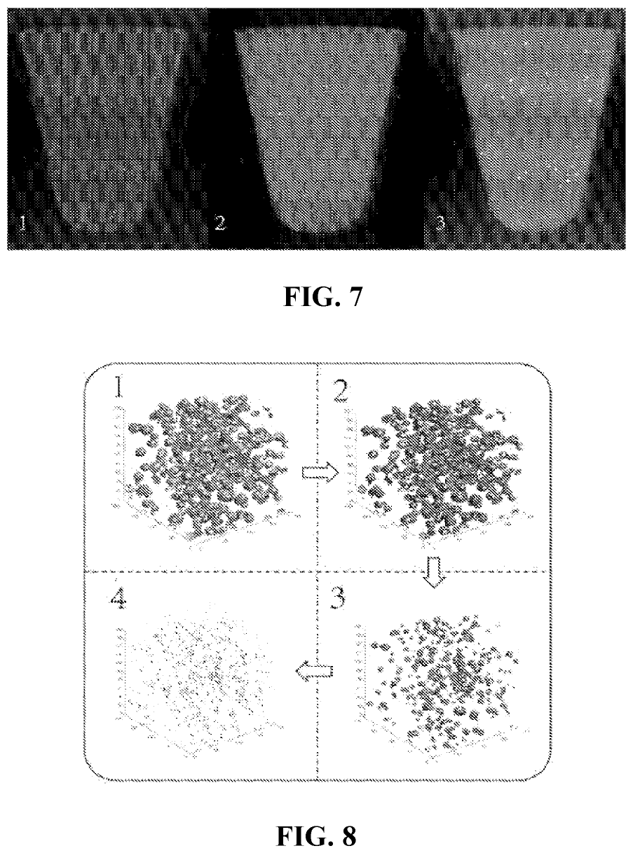

After the thermal cycle reaction is over, a device the same as the [*please confirm] described in FIG. 2 and FIG. 4 is used for detection. Multi-channel detection is performed on the transparentized droplets with illumination laser of multiple wavelengths. Each fluorescence channel is set to scan 400 pictures, and two channels scan 800 pictures. The scanning time is 4 s per channel, and in addition to the conversion time of 2 seconds, the total time is 10 s. FIG. 7(1) is a result of signal superimposition. FIG. 7(2) and FIG. 7(3) are fluorescence images of the same slice surface of the same sample, wherein FIG. 7(2) is a fluorescence signal at a 488 nm channel, and FIG. 7(3) is a fluorescence signal at 532 nm. As can be seen, the positions of bright spots in (2) and (3) are different, indicating that the method can effectively distinguish two different bases at the same site.

### Embodiment 2 Image Processing

Performing data processing on the captured multiple frames of images can achieve three-dimensional reconstruction, and achieve three-dimensional positioning and counting of droplets. For example, processing such as three-dimensional droplet reconstruction, Gaussian filter denoising, corrosion, signal enhancement, and local extremum or connected domain calculation is performed on the obtained images to realize the three-dimensional positioning and counting of the droplets. As shown in FIG. 8, 1 denotes three-dimensional droplet reconstruction, 2 denotes Gaussian filter denoising, 3 denotes corrosion and signal enhancement, and 4 denotes local extremum or connected domain calculation for the number of bright spots.

Although the preferred implementations of the present invention have been shown and described in the present application, it is obvious for those skilled in the art that these implementations are provided as examples only. Various alternations, changes, and replacements can now be made. It should be understood that various alternatives to the implementations of the present invention described in the present application can be used to implement the present invention. The scope of the present invention is limited only by the scope of the claims, and thus covers methods and structures within the scope of these claims and equivalent methods and structures.

1. A light sheet fluorescence microscopic imaging device for imaging transparentized droplets, comprising: a light source shaping module, a light sheet generation module, a sample control module, and an image capturing module, wherein the light source shaping module is used to shape circular light into an elliptical light spot; the light sheet generation module is used to generate a sheet-like light beam according to the elliptical light spot; the sample control module is used to control a sample to move in a direction perpendicular to an optical axis when the sample is illuminated by the sheet-like light beam; and the image capturing module is used to capture fluorescent signals excited in different positions when the sample is moving, so as to acquire a three-dimensional image sequence of the sample.

2. The light sheet fluorescence microscopic imaging device according to claim 1, wherein the volume of the light sheet fluorescence microscopic imaging device is within 30 cm×30 cm×15 cm.

3. The light sheet fluorescence microscopic imaging device according to claim 1, wherein the light source shaping module comprises: a laser, an optical fiber collimator, and a beam expanding and shaping module; and
wherein the optical fiber collimator is used to collimate the circular light emitted by the laser, and the beam expanding and shaping module is used to shape the collimated circular light into the elliptical light spot.

4. The light sheet fluorescence microscopic imaging device according to claim 2, wherein the beam expanding and shaping module comprises: a first cylindrical lens, a convex lens, and a second cylindrical lens sequentially arranged on the optical axis, and a focusing direction of the first cylindrical lens and a focusing direction of the second cylindrical lens form an angle of 90°.

5. The light sheet fluorescence microscopic imaging device according to claim 2, wherein the beam expanding and shaping module does not comprise a slit diaphragm.

6. The light sheet fluorescence microscopic imaging device according to claim 3, wherein compared with a device without the beam expanding and shaping module, the light sheet fluorescence microscopic imaging device has a higher energy utilization rate.

7. The light sheet fluorescence microscopic imaging device according to claim 5, wherein compared with a device without the beam expanding and shaping module, the energy utilization rate of the light sheet fluorescence microscopic imaging device is increased by more than four times.

8. The light sheet fluorescence microscopic imaging device according to claim 3, wherein compared with a device without the beam expanding and shaping module, the light sheet fluorescence microscopic imaging device has a reduced volume.

9. The light sheet fluorescence microscopic imaging device according to claim 4, wherein long and short axes of the elliptical light spot are f2*d/f1 and f3*d/f2, respectively; and
wherein f1, f2, and f3 are respectively the focal lengths of the first cylindrical lens, the convex lens, and the second cylindrical lens, and d is the diameter of an incident light spot.

10. The light sheet fluorescence microscopic imaging device according to claim 4, wherein the focal length f1 of the first cylindrical lens is 10 mm to 20 mm, the focal length f2 of the convex lens is 5 mm to 10 mm, and the focal length f3 of the second cylindrical lens is 15 mm to 30 mm.

11. The light sheet fluorescence microscopic imaging device according to claim 3, wherein the convex lens is a circular lens.

12. The light sheet fluorescence microscopic imaging device according to claim 1, wherein the image capturing module comprises: an objective lens, a tube lens, a filter, and a camera sequentially arranged on the optical axis, and a fluorescent signal detected by the objective lens is focused on a sensor of the camera through the tube lens to form an image; and the filter is used to transmit a signal of a fluorescent wavelength.

13. The light sheet fluorescence microscopic imaging device according to claim 7, wherein the magnification of the objective lens is 4× to 20×.

14. The light sheet fluorescence microscopic imaging device according to claim 7, wherein the focal length of the tube lens is 20 mm to 150 mm.

15. A method for imaging and detecting transparentized droplets, comprising:
(a) preparing transparentized emulsion containing an oil phase and an aqueous phase, wherein the refractive index of the oil phase matches that of the aqueous phase;
(b) performing a dropletization treatment on the transparentized emulsion to obtain transparentized droplets; and
(c) illuminating the transparentized droplets by the sheet-like light beam, and controlling the transparentized droplets to move in a direction perpendicular to the optical axis, thus capturing fluorescent signals excited in different positions when the transparentized droplets are moving, and acquiring a three-dimensional image sequence of the transparentized droplets.

16. The method according to claim 5, wherein circular light is shaped into an elliptical light spot, and a sheet-like light beam is generated according to the elliptical light spot.

17. The method according to claim 5, wherein in (a), the refractive index of the oil phase matching that of the aqueous phase specifically refers to that the oil phase and the aqueous phase have the same or similar refractive indexes.

18. The method according to claim 5, wherein a difference between the refractive indexes of the aqueous phase and the oil phase is within ±0.1.

19. The method according to claim 5, wherein, subsequent to (b), the transparentized droplets are subjected to a biochemical reaction.
